(19) United States
(12) Patent Application Publication
(10) Pub. No.: US 2008/0151375 A1
(43) Pub. Date: Jun. 26, 2008

(54) Light guide means as dually effected by light concentrating and light diffusing

(76) Inventor: Ching-Bin Lin, Taipei (TW)

Correspondence Address: Ching-Bin Lin, P.O. Box 55-846, Taipei, 104, omitted

(21) Appl. No.: 11/644,667

(22) Filed: Dec. 26, 2006

(51) Int. Cl. G02B 5/02

(52) U.S. Cl. 359/599; 359/831

(57) ABSTRACT

A light guide device comprises: a light guide plate made of transparent materials; and a light concentrating and diffusing structural portion integrally formed on an upper or outer portion of the light guide plate adjacent to a light-outgoing surface of the light guide plate in order to enhance the light concentrating effect and the light diffusing effect of the light guide plate.

### BACKGROUND OF THE INVENTION

A conventional back light module may be provided as a surface light source for illuminating a liquid crystal display and the like.

As shown in FIG. 1, a conventional back light module comprises: a side light type lamp (L), a light guide plate (G) positioned aside the lamp (L) for receiving and guiding light from the lamp (L) upwardly towards the liquid crystal plate through a light-outgoing surface of the light guide plate (G), and a plurality of optical sheets overlaid on the light guide plate (G) including an upper diffusion sheet (D1), an upper prism sheet (P1), a lower prism sheet (P2) and a lower diffusion sheet (D2) in order to enhance their light concentrating and diffusing effect.

However, such a conventional back light source may have the following drawbacks:
1. The prism sheets (P1, P2) and diffusion sheets (D1, D2) should be assembled and fastened on the light guide plate (G) to cause much assembly or production cost.
2. The gaps or apertures existing among the optical sheets may have repeated reflections, refractions or diffusions between every two neighboring sheets to cause optical loss, thereby reducing the overall light-output efficiency of the back light module.
3. The optical sheets may be mutually frictionally scrubbed or scratched to cause breakage or damage of the optical sheets, especially easily causing wearing on the peaks of the prisms of the prism sheets.
4. Even the elements including the optical sheets of the back light module may be physically or mechanically fastened, they may be structurally deformed or warped when subjected to internal stress or thermal stress, especially when the optical sheets are made thinner with a large area, thereby easily deteriorating their production quality.

The present inventor has found the drawbacks of the prior art and invented the present light guide means having light concentrating and diffusing effect.

### SUMMARY OF THE INVENTION

The object of the present invention is to provide a light guide device comprising: a light guide plate made of transparent materials; and a light concentrating and diffusing structural portion integrally formed on an upper or outer portion of the light guide plate adjacent to a light-outgoing surface of the light guide plate in order to enhance the light concentrating effect and the light diffusing effect of the light guide plate.

### BRIEF DESCRIPTION OF THE DRAWINGS

FIG. 1 is an illustration showing the elements in construction of a conventional back light module.

FIG. 2 is a sectional drawing of the present invention.

FIG. 3 is a partial perspective view of the present invention.

FIG. 4 shows another preferred embodiment of the present invention as modified from FIGS. 2, 3.

FIG. 5 shows still another preferred embodiment of the present invention.

FIG. 6 shows further preferred embodiment as modified from FIG. 5.

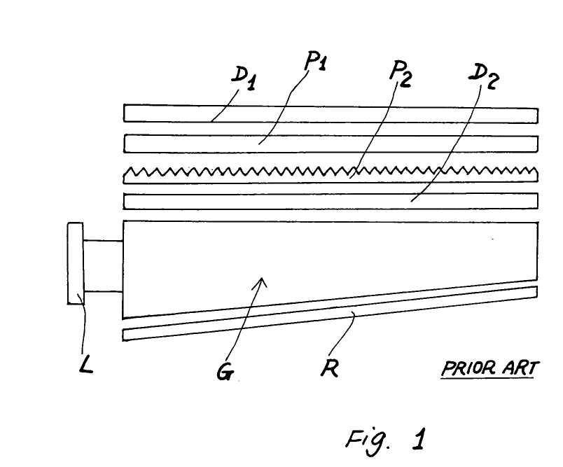

### DETAILED DESCRIPTION

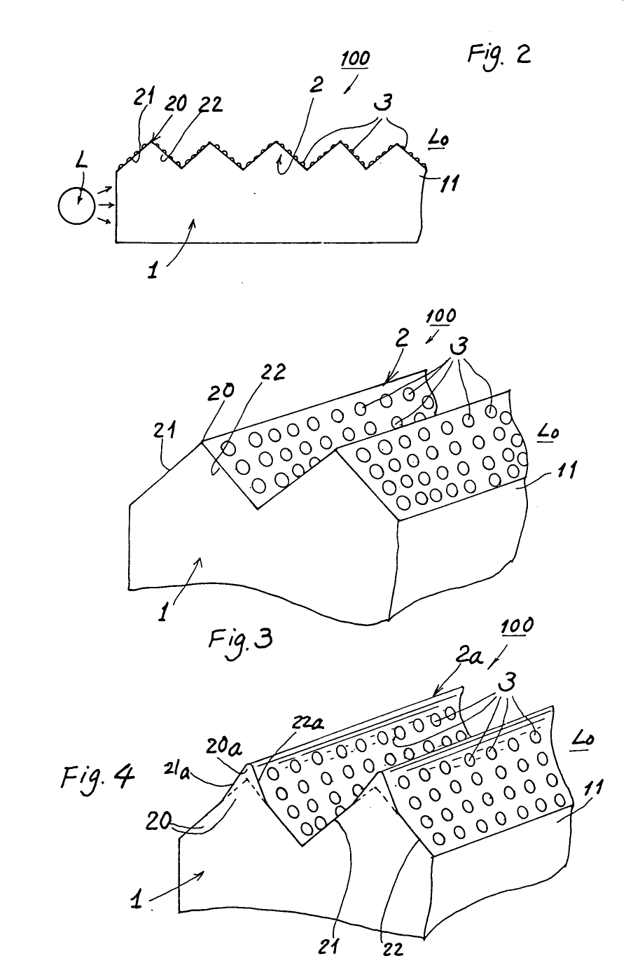

As shown in FIGS. 2 and 3, the light guide means of the present invention comprises: a light guide plate 1 made of transparent materials; and a light concentrating and diffusing structural portion 100 integrally formed on an upper or outer portion 11 of the light guide plate 1 adjacent to the light-outgoing surface Lo of the light guide plate 1.

The light concentrating and diffusing structural portion 100 includes a light concentrating structure 2 and a light diffusing structure 3, both integrally formed on an upper or outer portion 11 of the light guide plate 1.

A plurality of methods may be used for integrally forming such a light concentrating and diffusing structural portion 100 on the light guide plate 1, not limited in the present invention.

The light concentrating structure 2 comprises a prismatic structure having a plurality of prisms 20 integrally formed on the upper or outer portion 11 of the light guide plate 1, each prism 20 having dihedral faces 21, 22 tapered upwardly or outwardly from an uppermost portion of the light guide plate 1.

The light diffusing structure 3 includes a plurality of protrusions or recesses integrally formed on the dihedral faces 21, 22 of each prism 20 of the prismatic structure as shown in FIG. 3 for furnishing the light diffusing effect of the present invention.

Each protrusion (or recess) 3 may be formed as a shape selected from the group of shapes consisting of: a cone, a pyramid, a shuttle-like shape, a semisphere, a dome, an arcuate shape, a semi-cylindrical shape, a lens, an elongated shape or any other shapes, regular or irregular.

As shown in FIG. 4, the prismatic structure of the light concentrating structure 2 has been modified to be a multiple-story prismatic structure 2a, with each prism 2 having at least an upper prism element 20a integrally formed on an upper portion of the prism 2. Such a two-story or multiple-story prismatic structure may increase its light collecting efficiency, thereby preventing from light loss and thereby increasing brightness of the optical element. Each upper prism 20a has two upper dihedral faces 21a, 22a tapered upwardly or outwardly from the two dihedral faces 21, 22 of the lower prism 20.

The light guide plate 1 may be made of transparent resin materials, including: polycarbonate (PC), polymethyl methacrylate (PMMA), etc., not limited in the present invention.

The protrusions or recesses of the light diffusing structure 3 as aforementioned may be directly imprinted or formed on the upper or outer portion 11 of the light guide plate 1. The methods or processes for integrally forming the light diffusing structure 3 and the light concentrating structure 2 on the upper or outer portion of the light guide plate 1 are not limited in the present invention.

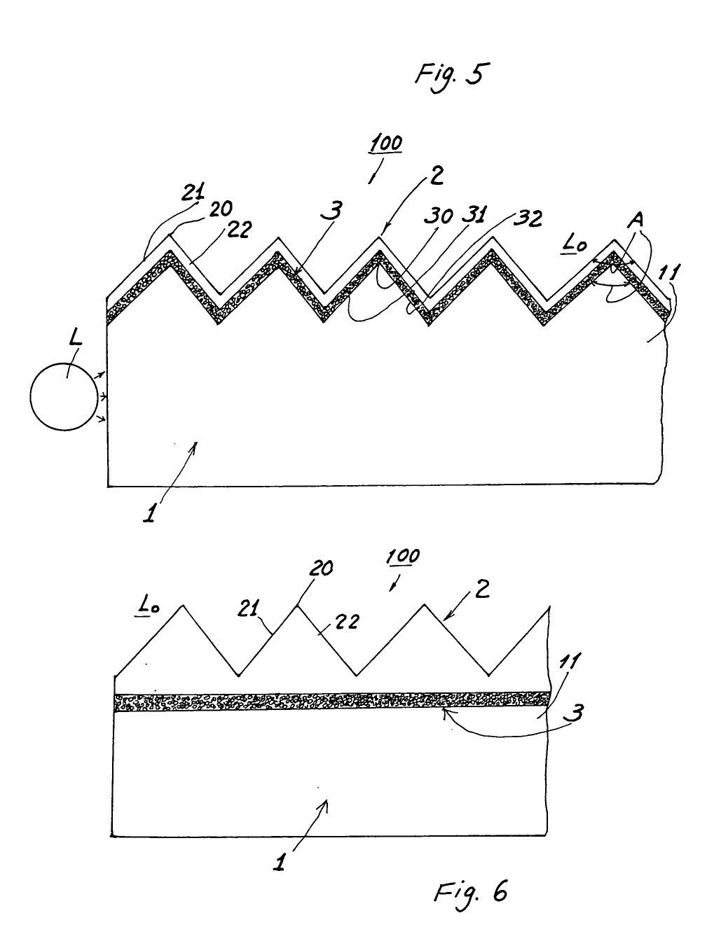

Another preferred embodiment of the present invention is shown in FIG. 5, in which the light concentrating and diffusing structural portion 100 comprises: an upper (or outer) light concentrating structure 2 and an inner (or lower) light diffusing structure 3 juxtapositioned (layer-by-layer) to the light concentrating structure 2.

The upper (or outer) light concentrating structure 2 may, of course, comprise a plurality of prisms 20 formed on an uppermost (or outermost) portion of the light guide plate 1, each prism 20 having dihedral faces 21, 22 tapered upwardly (or outwardly) from the uppermost portion of the light guide plate 1.

The lower (or inner) light diffusing structure 3 is juxtapositioned to and integrally formed in the light guide plate 1 under or inside the upper light concentrating structure 2.

The lower light diffusing structure as shown in FIG. 5 includes a saw-toothed light diffusing layer 3 having a plurality of teeth 30, each tooth 30 having dihedral tooth faces 31, 32 tapered upwardly to be juxtapositionally corresponding to the dihedral faces 21, 22 of each prism of the light concentrating structure 3; having an acute angle A defined between the dihedral faces 21, 22 of each prism 20 of the light concentrating structure 3 being same as an acute angle A defined between the dihedral tooth faces 31, 32 of each tooth 30 of the saw-toothed light diffusing layer 3.

The lower light diffusing structure (layer) 3 will enhance the light diffusing effect of the light guide plate 1; while the upper light concentrating structure (layer) 2 will enhance the light concentrating effect of the light guide plate 1, thereby enhancing the light uniformity and brightness of the back light module in accordance with the present invention.

As shown in FIG. 6, the above-mentioned sawtoothed light diffusing layer (FIG. 5) has been modified to be a flat or planar light diffusing layer for forming another preferred light diffusing structure 3 of the present invention.

As shown in FIGS. 5 and 6, the light diffusing structure 3 may include a plurality of channels or closed holes or pores in a porous structure layer to be juxtapositioned inside or under the light concentrating structure layer 2. The incidence light beams enter the channels or holes in the diffusing layer will be reflected repeatedly to cause the outgoing light uniformly, thereby increasing the light uniformity in cooperation with the brightness as effected by the light concentrating structure layer 2.

The light diffusing structure layer 3 may incorporate nano or micro particles into a polymer matrix, which is forming the diffusing structure having its strength and refractive index varied or adjusted as effected by the nano or micro particles as added therein, in order to enhance the optical properties or optical efficiency of the light guide means.

The present invention has the following advantages superior to the prior art:
1. The light concentrating structure 2 and the light diffusing structure 3 have been integrally formed on an upper or outer portion of the light guide plate 1 to thereby eliminate at least a prism sheet and a diffusion sheet overlaid on the light guide plate for saving production cost.
2. The light concentrating structure 2 and light diffusing structure 3 are formed in situ in the upper portion of the light guide plate 1 without forming the gaps or apertures between the conventional optical sheets or films so as to eliminate the light loss and to prevent warping or structural unstableness.
3. Like the “implantation” of a prism sheet (light concentrating structure 3) and a diffusing sheet (light diffusing structure 3) into the upper portion of the light guide plate 1, the whole set of a back light module of this invention can be minimized to greatly reduce its thickness and volume to be beneficial to optical, electronic, communication and information industries, all having a tendency to make the component or element to be thinner, slimmer or more miniaturized.

The present invention may be modified without departing from the spirit and scope of the present invention.

I claim:

1. A light guide means comprising:
a light guide plate made of transparent materials; and
a light concentrating and diffusing structural portion integrally formed on an upper or outer portion of said light guide plate adjacent to a light-outgoing surface of said light guide plate;
said light concentrating and diffusing structural portion including a light concentrating structure formed on said light guide plate for increasing light concentrating effect of the light guide plate, and a light diffusing structure formed on said light guide plate for increasing light diffusing effect of the light guide plate, thereby increasing brightness and light uniformity of the light guide plate.

2. A light guide means according to claim 1, wherein said light concentrating structure includes a prismatic structure having a plurality of prisms formed on the upper portion of said light guide plate, each said prism having dihedral faces tapered upwardly or outwardly from the light-outgoing surface; said dihedral faces having said light diffusing structure formed thereon.

3. A light guide means according to claim 2, wherein said light diffusing structure includes a plurality of protrusions integrally formed on said dihedral faces of said prisms; each said protrusion having a shape selected from the group of shapes consisting of: a cone, a pyramid, a semi-spherical shape, a dome, an arcuate shape, a cylindrical shape, a shuttle-like shape, and a lens protruding upwardly or outwardly from said dihedral faces of said prisms.

4. A light guide means according to claim 2, wherein said light diffusing structure includes a plurality of recesses recessed in said dihedral faces of said prisms; each said recess having a shape selected from the group of shapes consisting of: a cone, a pyramid, a semi-spherical shape, a dome, an arcuate shape, a cylindrical shape, a shuttle-like shape, and a lens recessed downwardly or inwardly from said dihedral faces of said prisms.

5. A light guide means according to claim 2, wherein said light concentrating structure includes a multiple-story prismatic structure having each said prism overlaid thereon with at least an upper prism; each said upper prism having two upper dihedral faces tapered upwardly or outwardly from the two dihedral faces of each said prism.

6. A light guide means according to claim 1, wherein said light diffusing structure is directly imprinted on the upper or outer portion of said light guide plate.

7. A light guide means according to claim 1, wherein said light concentrating and diffusing structural portion formed on said light guide plate includes an upper-layer light concentrating structure and a lower-layer light diffusing structure juxtapositionally formed under or inside the upper-layer light concentrating structure.

8. A light guide means according to claim 7, wherein said light concentrating structure, positioned above said light diffusing structure, includes a prismatic layer having a plurality of prisms integrally formed on an uppermost portion of said light guide plate; each said prism having dihedral faces tapered upwardly or outwardly from said uppermost portion of said light guide plate, and defining an acute angle between said two dihedral faces of said prism.

9. A light guide means according to claim 8, wherein said light diffusing structure includes a saw-toothed layer juxtapositionally formed under said prismatic layer, said saw-toothed layer including a plurality of teeth, each said tooth having dihedral tooth faces tapered upwardly and defining an acute angle between said two dihedral tooth faces to be same as the acute angle as defined between said two dihedral faces of said prism of said light concentrating structure.

10. A light guide means according to claim 7, wherein said lower-layer light diffusing structure includes a flat or planar light diffusing layer positioned under said upper-layer light concentrating structure.

11. A light guide means according to claim 7, wherein said light diffusing structure includes a plurality of channels or holes formed in a porous diffusing structure layer.

12. A light guide means according to claim 7, wherein said light diffusing structure includes incorporation of nano or micro particles into a polymer matrix for forming said light diffusing structure.
